(19) United States
(12) Patent Application Publication
(10) Pub. No.: US 2002/0083638 A1
(43) Pub. Date: Jul. 4, 2002

(54) Floating door fish pen

(76) Inventor: Charles A. Cunningham SR., Oskaloosa, IA (US)

Correspondence Address: SHUTTLEWORTH & INGERSOLL, P.L.C., 500 FIRSTAR BANK BUILDING, P O BOX 2107, CEDAR RAPIDS, IA, 52406, US

(21) Appl. No.: 09/681,098

(22) Filed: Jan. 4, 2001

(51) Int. Cl. A01K 97/04; A01K 97/00

(52) U.S. Cl. 43/54.1

(57) ABSTRACT

An improved pen for holding captured aquatic creatures in submerged confinement is disclosed. A non-buoyant housing is provided with a plurality of small, flow-accommodating openings of sufficient size to allow water to pass therethrough, but small enough to effectively confine captured creatures of a desired size. The pen also includes a buoyant door that is adapted to open in response to the exertion of downward pressure thereon if such pressure is sufficient to overcome the upward buoyant force exerted on the door by the surrounding water. Supports are provided to accommodate ropes, chains, or other lift assist means.

### BACKGROUND OF THE INVENTION

Fishing has long been a favorite recreational activity as well as a means for sustenance and income. After catching fish, it has been and continues to be common practice to hold the catch on a “stringer” or line that pierces the catch's mouth. When fishing from a boat, the stringer is commonly attached to the side of the boat and the captured fish are, hopefully, kept alive in the water beside the boat. Similarly a stringer may be attached to a dock, floating platform, or other structure if a fisherperson is not operating from a boat or if the fisherperson has returned to shore. Use of a stringer is messy and potentially dangerous. Piercing the fish's mouth causes the fish to bleed on the boat, dock, or other surface, and many trophy fish have sharp teeth making the process of stringing the fish awkward and potentially painful.

The prior art includes numerous alternatives to stringers. This prior art includes a wide variety of web, mesh or net means having a buoyant top wall or ring from which a mesh basket is suspended in the water. These “floating net” devices, like stringers, are typically attached to the side of a boat or dock to allow captured fish to remain in the water until the fisherperson is prepared to return to shore or until it is desired to remove the catch for cleaning. When fishing from the shore, or upon returning to shore (or to a dock or docking platform) it is also common to place the catch in a live well having a flow of fresh water being pumped therethrough to ensure adequate oxygen and to prevent a buildup of toxins in the well. The primary function of the stringer, the live well, and the mesh baskets is, of course, to maintain the captured fish in a live state to ensure or promote freshness until such time that the fish may be cleaned.

Whether land-based or vehicle-based, most live wells currently in use suffer from numerous drawbacks. Primary among these drawbacks are the need to provide a water circulation means. Another drawback is the need to place the catch on a stringer within the tank or well to minimize the risk of escape. In select containment devices such as bait buckets or traps for lobsters or other crustaceans, doors are provided with spring means therein to minimize risk associated with the escape of captured creatures through the entry port. Unfortunately, spring components are susceptible to corrosion and deterioration in the highly oxidizing environment of a tank or well. The risk of corrosion and deterioration (which may cause springs or doors to become stuck or fail completely) is enhanced if the apparatus is used in a salt-water environment.

Mesh or net bags, though convenient for storage and carrying, may become entangled within themselves, or with other objects. Many mesh bags include elastic or drawstring closure means. U.S. Pat. Nos. 4,890,413 (issued Jan. 2, 1990 to Nelson et al., the “'413” patent) and 1,841,956 (issued Jan. 19, 1932 to Juergens, the “'956 patent”) both disclose mesh bag fish pens having drawstring enclosures. In addition, many prior art fish pens exist wherein complex lid attachments and lid-locking or securing means are disclosed. Examples of such patents include U.S. Pat. Nos. 3,524,278 (issued Aug. 18, 1970 to Wolfe, the “'278 patent” disclosing spring closure means), 2,968,887 (issued Jan. 24, 1961 to Woolworth, the “'887 patent”), 5,529,204 (issued Jun. 25, 1996 to Sykes, the “'204 patent” disclosing a spring mounted door in a floatable bait bucket) 4,019,274 (issued Apr. 26, 1997 to Landell et al. the “'274 patent”), and 4,260,070 issued Apr. 7, 1981 to Pierson, the “'070 patent”).

Many of the discovered prior art references relate to floating pens or nets. One prior art reference, U.S. Pat. No. 3,919,803 issued Nov. 18, 1975 to Manguso, the “'803 patent”) discloses a floating net having a buoyant top ring from which a net or bag is suspended and against which a floating door is allowed to close. Similarly, U.S. Pat. No. 3,381,408 (issued May 7, 1968 to Nishimura the “'408 patent”) discloses a floating door used in combination with a mesh bag. Like other floating bag or mesh type fish holders, the inventions of the '803 patent and the '408 patent are designed to allow the entire apparatus to be suspended near the water's surface by a floatable member attached to the mesh body. Like all mesh or net bags, the inventions of the '803 patent and the '408 patent are susceptible to tangling and tearing. Further, upon removal from the water (or when still in the water) retrieval of fish or other items from the mesh bag may be complicated by entanglement of the item in the mesh.

Floating door means are beneficial because a relatively small amount of force applied to the exterior of the door may allow depression and opening of the door without the need to manipulate handles, levers, locks, etc. When placing the catch in the holder, it is common for the catch to be both slippery and energetic. Therefore, an easy-to-open door in a fish holder is highly desirable in order to free the user's hands to control the catch. Unfortunately, the combination of a floating door with a floating holder requires a balancing of forces by the user to apply adequate pressure to open the floating door without applying pressure sufficient to sink the entire holder. Further, the floating door means used in a floating mesh bag or net type fish holder is susceptible to inadvertent opening through wave action. Even in the absence of wave action, the floating door means disclosed in the prior art are susceptible to placement in the water in a position wherein the structure surrounding the floating door is upside-down in the water. In this position, the buoyant force of the water on the door causes the door to open and the open door in the upside-down structure allows captured fish to escape.

Therefore, there has been and remains a need for a fish pen or holder wherein the advantages of a floating door may be realized without the disadvantages that are associated with bag, mesh, or net type holders. Further there is a need for a floating door fish holder that is not itself buoyant whereby location of the holder in or out of the water may be controlled by the user and whereby the submerged holder may protect the door from wave action and be maintained in an upright position to prevent the inadvertent opening of the floating door. Finally there has been and remains a need for a durable fish pen and fish pen system wherein a floating door is positioned in a non-buoyant housing.

### BRIEF DESCRIPTION OF DRAWINGS

FIG. 1 is a perspective view of the floating door fish pen.

FIG. 2 is a side elevation view of the floating door fish pen.

FIG. 3 is a top view of the floating door fish pen.

FIG. 4 is a front view of the floating door fish pen.

FIG. 5 is a perspective view of the bottom side of the floating door fish pen top wall and door assembly.

FIG. 6 is a detailed perspective view of a door assembly buoyant mass support element.

FIG. 7 is a detailed perspective view of a door plate, hinge rod, and buoyant mass support element.

FIG. 8 is a detailed perspective view of a disassembled door assembly including floating door illustrating a buoyant mass, a buoyant mass support element, and a door plate.

FIG. 9 is a perspective view of the floating door fish pen having a rounded housing.

### DETAILED DESCRIPTION

A housing 2 defining a housing interior and having a top side 4 and a bottom side 6 is provided. The housing top side 4 has a port 8 formed therein. A door assembly 10 is moveably attached to said housing top side 2. The door assembly 10 is moveable between a closed position wherein the door is pressed upwardly towards the housing top side 4 to cover the port 8, and an open position wherein the door assembly 10 is angled downwardly from the housing top side 4. The door assembly 10 may be a unitary piece or a composite piece formed of various subparts. Regardless of the unitary or composite nature of the door assembly 10, it has an overall or composite density that is less than water. Similarly, the housing 2 may have a unitary or composite construction, and regardless of the nature of the construction, the housing 2 has an overall or composite density that is greater than water. In combination, the housing 2 and door assembly 10 have a composite or overall density that is greater than water. Supports 12 are attached to the housing 2 to allow suspension of the housing 2 in a body of water by the supports 12. In this manner, the assembly may hang or be otherwise suspended in a submerged state and the door assembly stays naturally closed without disturbance from surface effects such as wave action.

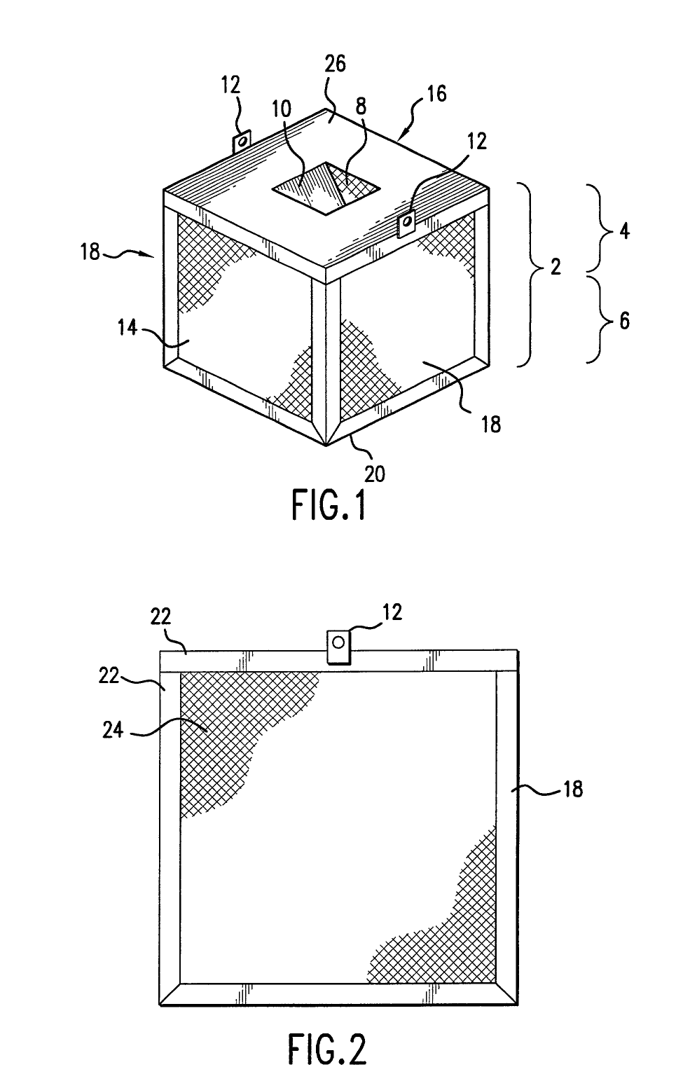

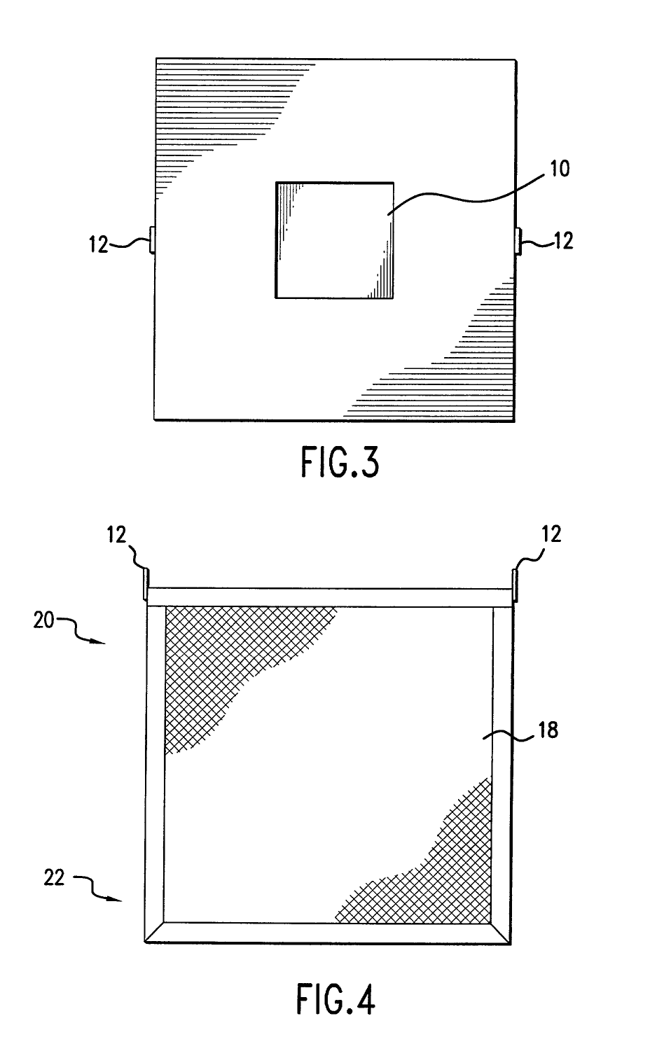

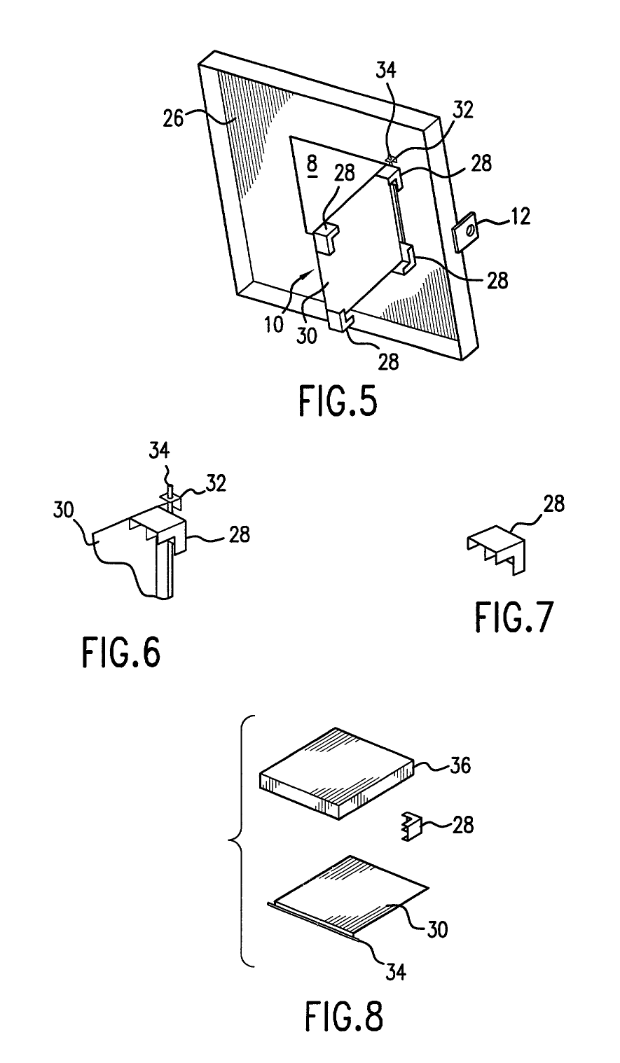

Describing the floating door fish pen now with reference to the presently preferred embodiments disclosed in FIGS. 1-9, the housing 2 comprises a front wall 14 being disposed generally parallel to a rear wall 16, and two side walls 18 being disposed generally parallel to one another and extending between the front wall 14 and the rear wall 16. A bottom wall 20 is attached to a bottom edge of the front wall, rear wall, and side walls, and a top wall is attached to a top edge of the front wall, rear wall, and side walls. The front, back, bottom, and side walls comprise surfaces having a plurality of openings formed therein. In order to allow for the relatively unhindered flow of water through the walls, it is preferred to provide walls of a generally reticulated structure having a substantially greater area defined by openings than defined by structural pieces. The walls may be plates having openings formed therein, or the walls may be formed of frame elements 22 having a perforated material, mesh, or webbing attached 24 thereto. The top wall 26 may similarly be formed with a plurality of openings formed therein such as a generally reticulated structure or a perforated plate or plates. It is, however, preferred to provide a top wall 26 that is solid (except for an entry port, if located thereon). Such a solid wall prevents captured fish within the pen from viewing activities above the pen by persons on docks, boats, etc. By limiting this view, the captured fish are less disturbed and are kept in a more relaxed state, thus minimizing the extent to which the fish react and thrash within the pen.

In FIGS. 1-4, the side 18, front 14, rear 16 and bottom 20 walls of the housing 2 are disclosed as frame elements 22 having perforated material 24 attached thereto. The presently preferred composition of the frame 22 and perforated material 24 is aluminum, which provides for a lightweight and resilient housing. In the alternative a material may be selected for use in a saline environment or under differing temperature extremes. Other preferred materials include various plastics as well as stainless steel, galvanized steel, or various metals in combination with an appropriate form of cathodic protection. Panels or sheets of perforated material, mesh, or webbing 24 may be permanently or removably attached to the frame elements 22. If the perforated material, mesh, or webbing 24 that is selected is a generally pliable material such as a natural or synthetic rope or flexible plastic mesh, the perforated material is mounted so that it is sufficiently taut to prevent the material from becoming entangled within itself.

The walls of the housing 2 may comprise adjoining plates rather than frame elements 22 that have panels or sheets of perforated material attached thereto. The selection of size for plates or frames and the selection of size for the openings formed therein will depend upon the size of the catch intended to be held therein, the preferred application is for the storage of trophy fish and fish intended for consumption. Therefore, holes having diameters or widths of less than about 2 inches are preferred. Of course, the pen may be fabricated in a wide array of sizes and a user's election of a desired pen size will depend upon the anticipated size of the catch the user intends to store in the pen. It is advantageous to provide pens of varying sizes for different users as excess pen space may make it more difficult to retrieve catch from the pen.

The top wall 26 preferably is a solid wall having an entry port 8 formed therein. Top wall hinge brackets 32 are affixed to an underside of the top wall. The hinge brackets 32 receive a hinge rod 34 that extends therebetween. In the presently preferred embodiment, the door assembly 10 is comprised of the hinge rod 34, a door plate 30, a plurality of buoyant mass supports 28 (illustrated in FIGS. 5-8 as support corners) and a buoyant mass 36. The door plate 30 is connected to the hinge rod 34, and the buoyant mass supports 28 are attached to the door plate 30. The buoyant mass is a block or mass of material that is positioned within the buoyant mass supports 28 and against the door plate 30. If preferred, the buoyant mass support may comprise an enclosure or casing for the buoyant mass. In this manner, the buoyant mass 36 may be protected from deterioration.

In the preferred construction, a buoyant mass support 28 is positioned sufficiently near to the hinge rod 34 to prevent the door assembly 10 from swinging away from the top wall entry port 8 beyond a generally vertical position. The buoyant mass 36 is selected to be of an appropriate density to make the overall door assembly 10 buoyant. It has been found that a Styrofoam™ block works well in this regard. In this manner, the upward buoyant force exerted by water upon the door assembly 10 causes the hinge rod 34 to rotate within the hinge brackets 32. Without buoyant mass supports 28 or other elements to constrain the range of motion of the door assembly, the buoyant force might pin the door assembly in a backwards or generally open position. Depending on the selected door assembly 10 construction (i.e. if a construction that does not include appropriately positioned buoyant mass supports 28 or other elements capable of preventing the door assembly from being held open by buoyant forces), it may be desired to place the entry port off-center or generally near an edge of the top wall 26. In this manner, the door assembly 10 may be prevented from “floating” to a generally open position by resistance from a side wall 18, front wall 14, or rear wall 16.

The door assembly may be constructed by alternative design. For example, a sealed air chamber may be used rather than a separate door plate 30, buoyant mass 28 supports, and buoyant mass 36. Similarly, the hinge brackets 32 and hinge rod 34 configuration are presently preferred due to their resiliency, the ease of construction, and the minimum of parts required. However, other hinge or moveable connection means may be employed. An inexpensive alternative design is the use of a flexible and low density plastic flap as the door assembly 10. The flap may be affixed by any convenient means to the housing. Buoyant forces cause the flap to close in a manner similar to that already described. For highly flexible or larger flaps, it is preferred to contain the flap in a rigid frame to ensure closure of the entry port and to prevent the flap from rolling or folding upon itself.

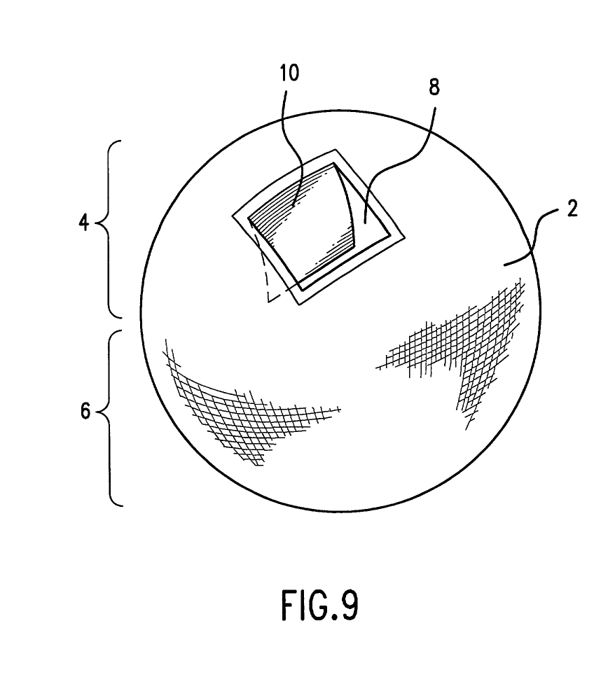

FIG. 9 illustrates a second preferred embodiment in FIG. 9, a large aluminum panel or screen is folded or formed into a generally spherical housing 2. The entry port 8 is formed in the housing top side 4, and a flap-type door assembly is attached interiorly thereto. For inexpensive construction, a generally conical housing 2 used in combination with a circular top wall may be fabricated with a minimum of parts.

Having explained the invention with reference to the preferred embodiments herein, it will be understood by those of skill in the art that the present invention is well adapted to achieve the stated objectives. It will be evident to those skilled in the art that various revisions can be made to the preferred embodiments without departing from the spirit and scope of the invention. It is my intention, however, that all such revisions and modifications that are evident to those skilled in the art will be included within the scope of the following claims.

1. A pen for holding captured aquatic creatures in submerged confinement comprising:
a housing defining a housing interior and having a top side and a bottom side;
said housing having a plurality of flow accommodating openings formed therein;
said pen having an overall density that is greater than the density of liquid water;
said housing top side having a port formed therein;
said port being adapted to received an aquatic creature that is less than or equal to a desired size;
said pen further comprising a door assembly disposed within said housing interior and being hingedly attached to the housing top side;
said door assembly having an overall density that is less than the density of liquid water;
said door assembly being disposed to move in response to buoyant forces generally from an open position to a closed position wherein the door assembly covers the top side port.

2. The pen of claim 1 further comprising:
housing supports attached to the housing.

3. The pen of claim 1 wherein:
the door assembly comprises a hinge rod, a door plate attached to said hinge rod, and a plurality of buoyant mass supports affixed to said door plate, said buoyant mass being attached thereto by said buoyant mass supports.

4. The pen of claim 3 wherein:
the housing further comprises a hinge bracket disposed within said housing interior generally adjacent to said port, said hinge bracket having an opening formed therein, and said hinge rod being disposed within said hinge bracket opening.

5. The pen of claim 1 wherein the door assembly comprises a plastic flap.

6. The pen of claim 1 wherein the door assembly comprises a hollow plastic wall.

7. The pen of claim 1 wherein the housing comprises:
a plurality of frame elements; and
a plurality of perforated panels attached thereto.

8. The pen of claim 1 wherein the housing comprises:
a plurality of perforated wall panels.

9. The pen of claim 1 wherein the housing comprises:
a generally spherically or conically folded perforated panel.

10. The pen of claim 1 wherein the door assembly comprises a hinged rod, a door plate attached to said hinged rod, a buoyant mass enclosure support, and a buoyant mass, said buoyant mass being confined in said buoyant mass enclosure support.
